(19) United States
(12) Patent Application Publication
(10) Pub. No.: US 2011/0048057 A1
(43) Pub. Date: Mar. 3, 2011

(54) GRILL UNIT FOR AIR CONDITIONER AND MANUFACTURING METHOD FOR THEREOF

(76) Inventors: Junsuk Lee, Changwon City (KR); Changhoon Jeong, Changwon City (KR); Hwanyong Nho, Changwon City (KR); Sunhyeong Lee, Changwon City (KR)

(21) Appl. No.: 12/865,210

(22) PCT Filed: Jan. 30, 2008
(86) PCT No.: PCT/KR08/00566

§ 371 Date: Nov. 18, 2010

(51) Int. Cl. F25D 17/04; B23P 19/04

(52) U.S. Cl. 62/408; 29/428

(57) ABSTRACT

The present disclosure relates to a grill unit for an air conditioner with a filter main body that filters impurities from air passing through airflow openings and is integrated with the grill unit, and a manufacturing method for the same. In a grill unit for an air conditioner according to the present disclosure, the grill unit defines airflow openings and includes a filter main body formed of a processed filter sheet and inserted and injection molded, and the filter main body includes folds having pluralities of peaks and valleys formed through folding and bending the filter sheet. Also, the folds include a plurality of fold supports provided at a side thereof to continuously support the folds therealong. A method for manufacturing a grill unit for an air conditioner according to the present disclosure includes forming a folded filter main body through folding and bending a filter sheet in operation (a), inserting the folded filter main body in an injection mold for forming the grill unit in operation (b), and integrally forming the filter main body and a filter frame and fold supports that support the filter main body, through injection molding the grill unit in operation (c). Thus, the number of parts and working processes can be reduced, and yield can be increased, to substantially reduce manufacturing costs.

### TECHNICAL FIELD

The present disclosure relates to a grill unit for an air conditioner with a filter main body that filters impurities from air passing through airflow openings and is integrated with the grill unit, and a manufacturing method for the same.

### BACKGROUND ART

In general, a grill unit 10 (shown in FIG. 1), for guiding indoor air into an indoor unit (not shown) from a lower end upward, includes a plurality of airflow openings 12 perforated in an upward and downward direction within the grill unit 10.

Also, a filter main body 14 that filters impurities included in indoor air that passes upward through the airflow openings 12 is provided above the grill unit 10. The filter main body 14 defines miniature holes that selectively allow only air from air and impurities to pass therethrough.

The filter main body 14 is supported by a filter support 16. Specifically, the filter main body 14 is supported by the filter support 16 so that the filter main body 14 is not deformed when contacting air flowing upward through the airflow openings 12 at a high rate of flow.

The filter support 16 is configured to slidably couple and be fixed to the upper surface of the grill unit 10. For this end, a filter guide 18 is provided at the left and right sides of the grill unit 10, respectively, to interfere with the left and right upper surfaces of the filter support 16, respectively, and secure the filter support 16 to the grill unit 10.

The filter guide 18 is fixed to the upper surface of the grill unit 10 through 6 fixing members 19.

However, the above-configured grill unit 10 according to the related art entails the following limitations.

Specifically, the grill unit 10 includes the filter support 16 that supports the filter main body 14, and the filter guide 18 and the plurality of fixing members 19 for fixing the filter support 16 to the upper surface of the grill unit 10.

Therefore, the filter main body 14 requires many processes such as a fixing process for fixing the fixing members 19 and a coupling process for coupling the filter main body 14 and the filter support 16, thereby inhibiting yield and increasing manufacturing cost.

Also, when a large amount of impurities amassed on the filter main body 14 necessitates cleaning, the filter support 16 nest be separated from the grill unit 10. Because the filter support 16 is substantial in size, when it is removed from and coupled to the indoor unit, user convenience is compromised.

### DISCLOSURE OF INVENTION

### Technical Problem

An object of the present disclosure is to provide a method for manufacturing a grill unit for an air conditioner with a filter main body that filters impurities from air passing through airflow openings that is integrated with the grill unit, to reduce the number of components, increase yield, and reduce manufacturing cost.

Another object of the present disclosure is to provide a grill unit for an air conditioner that facilitates cleaning and maintenance of a filter main body by allowing the filter main body to be separated from the air conditioner together with the grill unit.

### Technical Solution

In one embodiment, a grill unit for an air conditioner includes a filter main body formed of a processed filter sheet and inserted and injection molded, the grill unit defines airflow openings, and the filter main body includes folds having pluralities of peaks and valleys formed through folding and bending the filter sheet.

In another embodiment, a method for manufacturing a grill unit for an air conditioner includes forming a folded filter main body through folding and bending a filter sheet in operation (a), inserting the folded filter main body in an injection mold for forming the grill unit in operation (b), and integrally forming the filter main body and a filter frame and fold supports that support the filter main body, through injection molding the grill unit in operation (c), and operation (c) includes forming the fold supports in plurality continuously along folds of the filter main body.

### ADVANTAGEOUS EFFECTS

An advantage of a grill unit for an air conditioner according to the present disclosure is that a filter main body for filtering impurities from air is integrally formed with the grill unit by being inserted in an injection mold.

Accordingly, separate components for coupling the filter main body and the grill unit are unnecessary, so that the number of components is reduced, thereby increasing yield and substantially reducing manufacturing cost.

Additionally, according to the present disclosure, because the filter main body and the grill unit are integrated, when the grill unit is separated from the air conditioner, the filter main body is separated together, so that the danger of injury sustained from the filter main body falling, etc. may be reduced.

Furthermore, because impurities amassed on the filter main body may be cleaned together with the grill unit, cleaning and maintenance are made easier.

### BRIEF DESCRIPTION OF THE DRAWINGS

FIG. 1 is a top perspective view showing the structure of a grill unit for an air conditioner according to the related art.

FIG. 2 is a bottom perspective view showing a grill unit for an air conditioner according to the present disclosure when open.

FIG. 3 is a bottom perspective view of a grill unit for an air conditioner according to the present disclosure.

FIG. 4 is a top perspective view of a grill unit for an air conditioner according to the present disclosure.

FIG. 5 is a detailed sectional perspective view of a filter main body that is a component of a grill unit for an air conditioner according to the present disclosure.

FIG. 6 is a sectional perspective view taken along line I-I′ in FIG. 4.

FIG. 7 is a sectional perspective view taken along line II-II′ in FIG. 4.

FIG. 8 is a sectional perspective view taken along line III-III′ in FIG. 4.

FIG. 9 is a sectional perspective view taken along line IV-IV′ in FIG. 4.

FIG. 10 is a sectional perspective view taken along line V-V′ in FIG. 4.

FIG. 11 is cross-sectional view showing the forming of a grill that is a component of a grill unit for an air conditioner, according to one embodiment of the present disclosure.

FIG. 12 is a cross-sectional view showing the forming of a grill that is a component of a grill unit for an air conditioner, according to another embodiment of the present disclosure.

### MODE FOR THE INVENTION

Below, the configuration of a ceiling mounted air conditioner according to embodiments of the present disclosure will be described, with reference to FIG. 2.

FIG. 2 is a bottom perspective view showing a grill unit for an air conditioner according to the present disclosure when open.

Referring to FIG. 2, the ceiling maimed air conditioner 1 is fixed and installed upward into a ceiling. Also, the air conditioner is configured to first suction indoor air therein, perform heat exchanging with refrigerant, and then discharge the air back into the indoor space.

Accordingly, the exterior of the undersurface of the air conditioner includes a grill unit 100 for guiding suctioned indoor air into the air conditioner, and an outer panel 10 that guides discharging of air that has undergone heat exchanging back into the indoor space.

In more detail, the grill unit 100 is disposed at the central portion of the outer panel to form the lower central exterior of the air conditioner, and guides indoor air therethrough in an upward direction.

Also, the outer panel is disposed to the outside of the grill unit, and defines cutlets 12 elongated in four directions to guide the discharging of heat exchanged air downward into the indoor space.

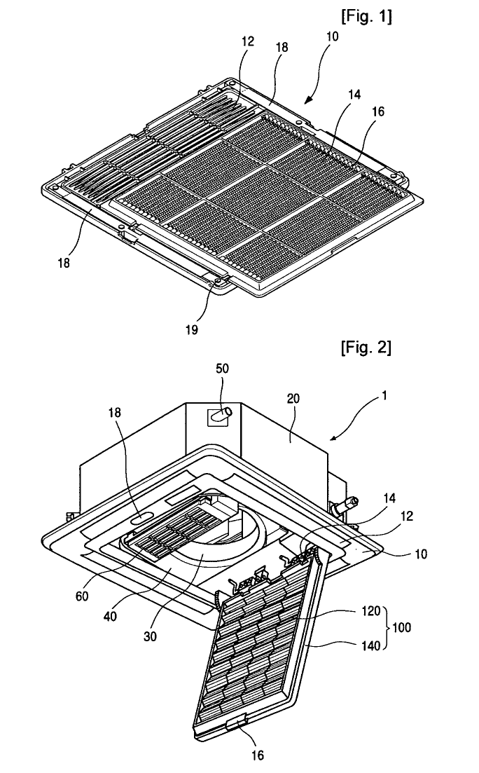

The grill unit is rotatable about the rear end thereof, as shown in FIG. 1, and is coupled to be selectively separated from the air conditioner. That is, a hinge 14 is provided at the top of the grill unit, and the hinge is separably coupled to a corresponding member formed within the outer panel.

Accordingly, the grill unit rotates about the hinge to allow the inside of the air conditioner to be opened, and the grill unit can be separated from the air conditioner by separating the hinge and the corresponding member.

Also, a latch 16 is provided at the lower end of the grill unit. The latch is configured to maintain the grill unit in a closed state when the latter is rotated clockwise to seal the inside of the air conditioner.

An open button 18 is provided at the front of the outer panel to selectively couple to the latch and selectively disengage to open the grill unit.

A detailed description of the grill unit's configuration will be provided below.

The outer panel is provided with a cabinet 20 at the upper end thereof. The cabinet defines the upper exterior of the air conditioner, and defines a space in which a plurality of components is housed.

A shroud 30 is provided in the inner, central portion of the cabinet. The shroud is for guiding indoor air flowing upward through the grill unit into the air conditioner, and is cylindrical in shape with a low height.

A drain pan 40 is provided to the outside of the shroud. The drain pan is configured to collect condensate that descends from a heat exchanger exchanging heat between indoor air and refrigerant, and has a downwardly recessed upper surface.

The condensate collected in the drain pan is drained to the outside of the air conditioner through a drain pipe 50 that passes through the front of the cabinet and is exposed to the outside of the cabinet.

A plasma filter is provided below the drain pan. The plasma filter removes impurities from indoor air entering the air conditioner through the grill unit by burning the impurities through plasma.

That is, the plasma filter removes impurities not removed by the filter main body provided on the grill unit which enter the inside of the air conditioner in a second stage.

The grill unit has the filter main body that removes impurities from indoor air inserted therein.

That is, with the filter main body inserted in an injection mold, the grill unit is integrally formed through injection molding.

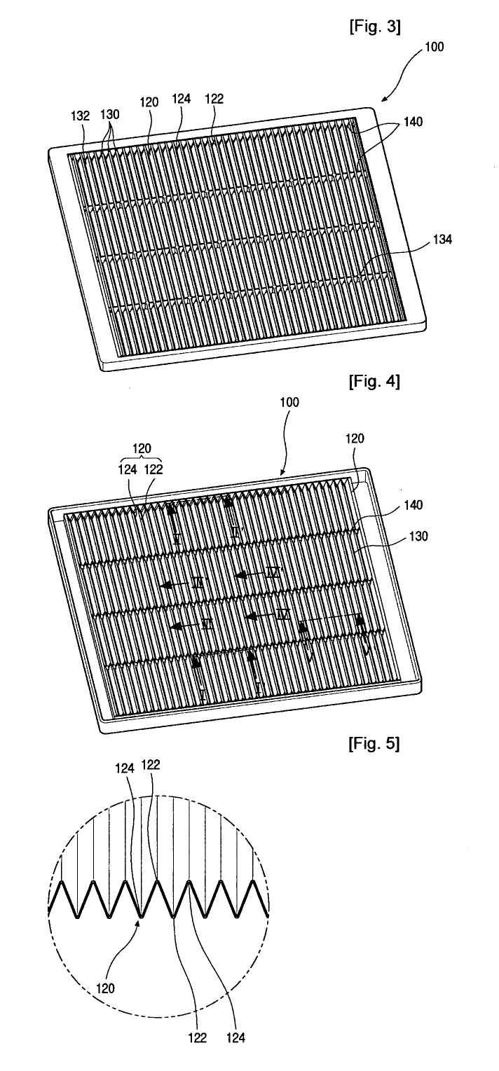

Below, the configuration of the grill unit will be provided in detail with reference to FIGS. 3 to 5.

FIG. 3 is a bottom perspective view of a grill unit for an air conditioner according to the present disclosure, FIG. 4 is a top perspective view of a grill unit for an air conditioner according to the present disclosure, and FIG. 5 is a detailed sectional perspective view of a filter main body that is a component of a grill unit for an air conditioner according to the present disclosure.

Referring to these diagrams, the grill unit has a roughly rectangular plate shape, and has the filter main body inserted and fixed within.

The filter main body is formed with a filtering sheet that is folded, as shown in FIG. 5, to have corrugations with a plurality of peaks and valleys. The filtering sheet is made of a washable material.

Then, when the filter main body is disposed below the upper surface shown in FIG. 3 so as not to protrude outwardly, during the injection molding of the grill unit, the filter main body is restricted from movement by a plurality of formations formed integrally with the grill unit.

That is, a plurality of grills 130 is formed in a vertically elongated manner in the central portion of the upper surface of the grill unit (in FIG. 3). The grills are formed to have uniform gaps laterally therebetween, and are formed integrally with the grill unit when the latter is injection molded.

Thus, the gaps between the plurality of grills define airflow openings 132, and the airflow openings guide indoor air to pass downward therethrough.

The plurality of grills are respectively formed on the peaks of the filter main body to support the filter main body. That is, the plurality of grills are formed on peaks protruding sharply toward the surface forming the lower surface (in FIG. 3) of the air conditioner, from both sides of the grill unit.

Accordingly, the grill prevents entry of sharp impurities from the outside, and also prevents accidents due to fingers inserted by careless users.

The plurality of formations formed integrally with the grill unit when the latter is injection molded includes fold supports 140. The fold supports are continually formed along the folds of the filter main body to support the folds.

Specifically, the fold supports are formed elongated in the direction of the folds (horizontally) along the filter main body (as shown in FIG. 3), and include a total of 4—one at the trailing end, one at the leading end, and two in the middle—that are equidistant from each other.

Thus, the filter main body can be supported so as not to undulate in upward/downward directions by means of the fold supports.

The remainder of the plurality of formations that are formed during the injection molding of the grill unit includes a filter frame 150.

The filter frame, as shown in FIG. 4, is roughly rectangular in shape, and is formed to protrude upward from the inside of the upper surface of the grill unit. The filter main body is disposed within the filter frame.

The filter frame corresponds in external shape and size to the filter main body, and ends of the filter main body are inserted in and coupled to the inner surfaces of the filter frame.

Accordingly, the perimeter of the filter main body is supported by the filter frame, and the inner portion is supported by the grills.

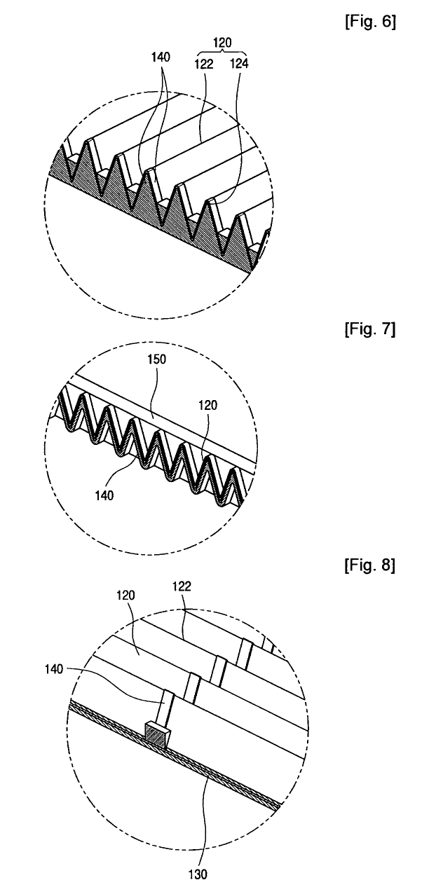

Below, the coupling structure of the fold supports will be described with reference to FIGS. 6 and 7.

FIG. 6 is a sectional perspective view taken along line I-I′ in FIG. 4, and FIG. 7 is a sectional perspective view taken along line II-II′ in FIG. 4.

Referring to the drawings, the fold supports are tightly formed with the filter main body when the filter main body is inserted in the injection mold and injection molded, and, as shown in FIGS. 6 and 7, the fold supports are formed to enclose both the peaks and valleys along the folds of the filter main body.

In further detail, when a plastic resin is injected into an injection mold with the filter main body inserted in the injection mold, the plastic resin passes through the filter main body progressively upward from the bottom and hardens to form the fold supports.

Thus, the filter main body is disposed to the inside of the fold supports, to be enclosed by the fold supports.

Also, the fold supports are integrally formed with the filter. That is, the left and right ends of the fold supports shown in FIG. 6 contact the left and right sides of the filter (shown in FIG. 4) to be integrally formed with the filter.

Further, the fold supports shown in FIG. 7 (the fold supports supporting the leading and trailing ends of the filter main body in FIG. 4) are connected to the filter frame at the trailing end and integrally formed with the filter frame, so that the trailing ends of the fold supports are sealed with the filter frame.

The fold supports of the plurality of fold supports that are formed at the perimeter of the filter main body are formed wider than the remaining fold supports, and are also thicker than the remaining fold supports.

Therefore, the filter main body is supported by the plurality of fold supports so that undulation is reduced, and is also firmly supported by the fold supports 140 (in FIG. 7) at the perimeter thereof.

The fold supports are integrally formed with the grill. That is, the fold supports (as shown in FIG. 8) are formed to enclose the peaks and valleys below the filter main body, and the lower portions of the fold supports are integrally formed with the grill.

In more detail, the grill is integrally formed from the lower end of a grill support to extend in a perpendicular direction.

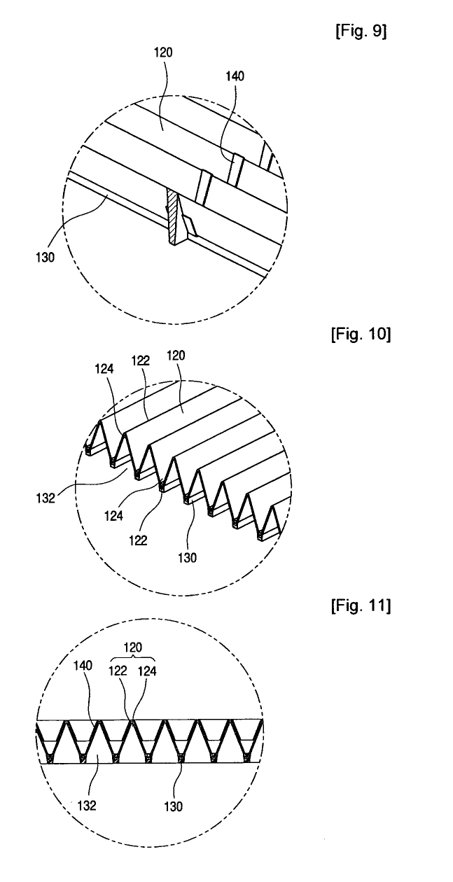

Below, the configurations of the fold supports and the grill will be provided in detail, with reference to FIGS. 9 to 12.

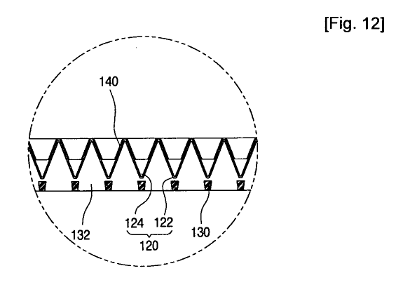

FIGS. 9 and 10 are sectional perspective views taken along line IV-IV′ and V-V′ in FIG. 4, FIG. 11 is cross-sectional view showing the forming of a grill that is a component of a grill unit for an air conditioner, according to one embodiment of the present disclosure, and FIG. 12 is a cross-sectional view showing the forming of a grill that is a component of a grill unit for an air conditioner, according to another embodiment of the present disclosure.

As shown in the diagrams, the fold supports are sloped with a trapezoidal shape having a downwardly decreasing width (as shown in FIG. 9).

This is to facilitate ejecting of the grill unit from inside an injection mold during injection molding of the grill unit with the filter main body inserted therein.

The grills are also sloped and formed to have a trapezoidal cross section with a downwardly decreasing width. The trapezoidal cross section of the grills is also for facilitating ejection of the grill unit formed inside an injection mold.

In addition, as described above, the lower ends of the fold supports are integrally formed with the fold supports, and the plurality of peaks below the filter main body are disposed higher than the lower ends of the grills.

Accordingly, the filter main body is supported in the directions of the folds by the fold supports, and the plurality of peaks disposed below the filter main body is supported by the grills.

Also, the plurality of grills may be formed at various locations on the folds within parameters intersecting with the fold supports.

That is, the grills may be formed at the lower end of the filter main body (as shown in FIG. 10), and may be elongated from the front to rear at a side of the filter main body.

Also, the grills may be diversely embodied within positions lower than the lower peaks of the filter main body, in order to form the exterior of the grill unit.

That is, the grills may be formed by being tightly coupled with the filter main body as shown in FIG. 11, or the grills and the filter main body may be separated from one another as shown in FIG. 12.

Here, airflow openings are defined between the plurality of grills, and indoor air guided upward through the airflow openings passes through the filter main body to be filtered of impurities.

In addition, the filter main body is supported by the fold supports and/or the grills, so that it is prevented from undulating when brought into contact with air flowing upward through the airflow openings.

Below, a manufacturing method of the above-configured grill unit for an air conditioner will be described with reference to FIGS. 3 to 12.

First, the filter main body is formed in operation (a). In operation (a), a filter sheet is folded in a zigzag shape to form folds including peaks and valleys. The folded filter main body has a cross sectional shape shown in FIG. 5.

The filter main body formed in operation (a) is inserted in an injection mold in operation (b) to injection mold the grill unit.

In operation (b), the filter main body is seated in the injection mold, melted plastic resin is injected into the injection mold above a few of the plurality of points at which the fold supports and the grills intersect, and gates (not shown) for guiding the filling of the plastic resin to form the grill unit are disposed at several locations.

When operation (b) is completed, and when plastic resin is injected from the injection molding machine following the sealing of the injection mold, the plastic resin has filled the inside of the mold through the plurality of gates.

Here, when the plastic resin integrally forms the filter frame, fold supports, and grills, the filter main body is simultaneously tightly formed with the fold supports or the grills, as shown in FIGS. 6 to 10.

In further detail, the fold supports are formed in plurality continually along the folds of the filter main body, and the filter frame is formed at the outside of the fold supports.

Also, grills are formed apart from each other perpendicularly to the fold supports at the bottom end of the fold supports, to define airflow openings.

In operation (c) the fold supports and the grills, as shown in FIGS. 9 and 10, are formed to have cross-sectional widths that progressively narrow downward.

Accordingly, when the integral forming of the filter frame, grills, and fold supports is completed with the filter main body inserted in the injection mold, the ejection of the grill unit from the injection mold is facilitated by the sloped cross section of the fold supports and the grills.

Also, gateways 134 are formed in plurality at several intersecting points between the fold supports and the grills, to guide the flow of plastic resin injected from the injection molding machine.

The reason for forming the gateways that position gates at intersecting points between the fold supports and the grill is to increase flow of plastic resin within the injection mold and lower the rate of defects.

The grills may be formed in operation (c) to be configured as shown in FIGS. 11 and 12 according to requirements.

That is, FIG. 11 shows an embodiment in which the grills and the filter main body are tightly formed in contact with one another, and FIG. 12 shows another embodiment in which the grills and the filter main body are formed separated from one another.

The forming of the grills may be performed according to various embodiments, and the plurality of grills are spaced apart from each other to define the airflow openings.

When the manufacturing of the grill unit is completed through the above operations, the grill unit is coupled to be selectively separable from the outer panel to filter impurities from indoor air.

It should be understood that the spirit and scope of the present disclosure are not limited to the above-described illustrative embodiments thereof, and that numerous other modifications and embodiments can be devised by those skilled in the art, on the basis of the present disclosure.

1. A grill unit for an air conditioner, the grill unit defining airflow openings and comprising a filter main body formed of a processed filter sheet and inserted and injection molded.

2. The grill unit according to claim 1, wherein the filter main body comprises folds having pluralities of peaks and valleys formed through folding and bending the filter sheet.

3. The grill unit according to claim 1, further comprising a filter frame integrally formed with the grill unit and the filter main body through plastic resin.

4. The grill unit according to claim 2, wherein the folds comprise a plurality of fold supports provided at a side thereof to continuously support the folds therealong.

5. The grill unit according to claim 4, further comprising a filter frame integrally formed with the grill unit through plastic resin, wherein the filter frame seals those of the plurality of fold supports that are formed outside the filter main body.

6. The grill unit according to claim 5, wherein those of the plurality of fold supports in contact with the filter frame have a width greater than a width of fold supports not in contact with the filter frame.

7. The grill unit according to claim 1, further comprising a plurality of grills formed on one of both sides of the filter main body, the grills defining the airflow openings.

8. The grill unit according to claim 7, wherein the filter main body comprises folds having pluralities of peaks and valleys formed through folding and bending the filter sheet, and the grills are formed on the peaks, respectively.

9. The grill unit according to claim 7, wherein the filter main body comprises folds having pluralities of peaks and valleys formed through folding and bending the filter sheet, and the grills are formed separated from the peaks.

10. The grill unit according to claim 7, wherein the filter main body comprises folds having pluralities of peaks and valleys formed through folding and bending the filter sheet, the grills are formed on a portion of the folds, and the peaks are disposed above the grills.

11. The grill unit according to claim 7, wherein the filter main body comprises:
folds at a side thereof, the folds having pluralities of peaks and valleys formed through folding and bending the filter sheet; and
a plurality of fold supports supporting the folds, the filter main body being tightly formed against the fold supports or the grills when insert injected therewith.

12. The grill unit according to claim 7, wherein the filter main body comprises:
folds at a side thereof, the folds having pluralities of peaks and valleys formed through folding and bending the filter sheet; and
a plurality of fold supports supporting the folds, the fold supports being integrally formed with the grills.

13. The grill unit according to claim 11, farther comprising one or more gateways provided at points of intersection between the fold supports and the grills, the gateways gliding a flow of plastic resin from an injection molding machine to the fold supports and the grills.

14. The grill unit according to claim 11, wherein the fold supports and/or the grills have sloped cross-sectional shapes.

15. The grill unit according to claim 3, wherein the grill unit is selectively separable from the air conditioner.

16. A method for manufacturing a grill unit for an air conditioner, the method comprising:
forming a folded filter main body through folding and bending a filter sheet in operation (a);
inserting the folded filter main body in an injection mold for forming the grill unit in operation (b); and
integrally forming the filter main body and a filter frame and fold supports that support the filter main body, through injection molding the grill unit in operation (c).

17. The method according to claim 16, wherein operation (c) comprises forming the fold supports in plurality continuously along folds of the filter main body.

18. The method according to claim 16, wherein operation (c) comprises forming a plurality of grills on one of both sides of the filter main body, the grills defining airflow openings.

19. The method according to claim 18, wherein operation (c) further comprises forming the fold supports separated from the filter main body.

20. The method according to claim 18, wherein operation (c) further comprises tightly forming the filter main body against the fold supports or the grills.

21. The method according to claim 18, wherein operation (c) further comprises progressively reducing cross-sectional widths of the fold supports and the grills in a predetermined direction.

22. The method according to claim 18, wherein operation (c) further comprises providing one or more gateways at intersecting points between the fold supports and the grills, the gateways gliding a flow of plastic resin injected from an injection molding machine.
